(19) United States
(12) Patent Application Publication
(10) Pub. No.: US 2023/0237444 A1
(43) Pub. Date: Jul. 27, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Aichi-ken (JP)

(72) Inventors: Kenji YAMAGUCHI, Miyoshi-shi (JP); Yusuke KUZUYA, Toyota-shi (JP); Yoshikazu JIKUHARA, Miyoshi-shi (JP); Kosuke SAKAKIBARA, Toyota-shi (JP); Takashi HAYASHI, Nagoya-shi (JP)

(21) Appl. No.: 17/979,763

(22) Filed: Nov. 3, 2022

(30) Foreign Application Priority Data
Jan. 25, 2022 (JP) 2022-009702

(51) Int. Cl. G06Q 10/20

(52) U.S. Cl. CPC G06Q 10/20

(57) ABSTRACT

An information processing device includes: a storage unit configured to previously store user information for each user with which vehicle information relevant to a vehicle is capable of being registered, the user information being associated with a location of the user and an acceptance or rejection of registration of data; an acquisition unit configured to acquire search information for searching for the user; an identification unit configured to identify the user information corresponding to the acquired search information; and a presentation unit configured to present map information in which a user capable of accepting the registration of the data is set on a map, at the location related to the identified user information.

### CROSS-REFERENCE TO RELATED APPLICATION

This application claims priority to Japanese Patent Application No. 2022-009702 filed on Jan. 25, 2022, incorporated herein by reference in its entirety.

### BACKGROUND

### 1. Technical Field

The present disclosure relates to an information processing device, an information processing method and a storage medium that present a user (special business operator) with which vehicle information relevant to a vehicle can be registered in the case where the vehicle information is managed by a system.

### 2. Description of Related Art

Japanese Unexamined Patent Application Publication No. 2003-132261 discloses a vehicle maintenance information provision method by which an information provider can visually determine information easily and can provide information quickly at the time of the provision of information about vehicle maintenance to a customer. Also as for vehicle accessories, there is disclosed a method for providing necessary maintenance information in response to a demand from a user.

### SUMMARY

For example, in some cases, a user (special business operator) that receives a request for the maintenance of the vehicle or the like does not accept the registration of data related to the maintenance of the vehicle or the like in a database. Therefore, in the case where the owner of the vehicle hopes to register vehicle information about the vehicle in a database, the owner of the vehicle needs to seek a user that accepts the registration, and there is a possibility of increase in burden.

The present disclosure has an object to provide an information processing device, an information processing method and a storage medium that can reduce the burden of the seeking for the user that accepts the registration in the case where the owner of the vehicle hopes to register the vehicle information in the database.

An information processing device described in claim 1 includes: a storage unit configured to previously store user information for each user with which vehicle information relevant to a vehicle is capable of being registered, the user information being associated with the location of the user and an acceptance or rejection of registration of data; an acquisition unit configured to acquire search information for searching for the user; an identification unit configured to identify the user information corresponding to the acquired search information; and a presentation unit configured to present map information in which a user capable of accepting the registration of the data is set on a map, at the location related to the identified user information.

The information processing device described in claim 1 previously stores the user information associated with the location of the user and the acceptance or rejection of the registration, for each user with which the vehicle information relevant to the vehicle is capable of being registered. In the case of acquiring the search information for searching for the user, the information processing device identifies the user information corresponding to the search information, and presents the map information in which the user information that is of the identified user information and that is capable of accepting the registration is set on the map, at the location related to the identified user information. Thereby, in the case where the owner of the vehicle hopes to register the vehicle information about the vehicle in the database, the owner of the vehicle can reduce the burden of the seeking for the user that accepts the registration.

As an information processing device described in claim 2, in the information processing device according to claim 1, the presentation unit may present map information in which a user that does not accept the registration of the data is further set on the map.

With the information processing device described in claim 2, it is possible to further search for the user that does not accept the registration of the data, and to select a larger number of users in consideration of whether the data is registered.

As an information processing device described in claim 3, in the information processing device according to claim 1 or 2, the user information may further include the attribute of the user, the search information may further include the attribute, and the identification unit may identify the user information corresponding to the acquired attribute.

With the information processing device described in claim 3, it is possible to search for the user that is a search object, for each attribute, and to further reduce the burden of the seeking for the user.

As an information processing device described in claim 4, in the information processing device according to any one of claims 1 to 3, the presentation unit may further present the identified user information in a list.

With the information processing device described in claim 4, it is possible to more easily check a candidate for the identified user.

As an information processing device described in claim 5, in the information processing device according to any one of claims 1 to 4, the user information may include a registration history that is an item for the vehicle information registered by the user in the past, the acquisition unit may further acquire the vehicle information registered for the vehicle, and the identification unit may identify the user information related to the registration history corresponding to the acquired vehicle information.

With the information processing device according to claim 5, it is possible to recognize the user that can accept the registration and that corresponds to the registered the vehicle information.

As an information processing device described in claim 6, the information processing device according to any one of claims 1 to 5 may further include an acceptance unit configured to accept an alteration of the acceptance or rejection related to the user information.

With the information processing device described in claim 6, it is possible to present the user information in accordance with the current situation of the user.

In an information processing method described in claim 7, a computer executes: a process of previously storing user information for each user with which vehicle information relevant to a vehicle is capable of being registered, the user information being associated with the location of the user and an acceptance or rejection of registration of data; a process of acquiring search information for searching for the user; a process of identifying the user information corresponding to the acquired search information; and a process of presenting map information in which a user capable of accepting the registration of the data is set on a map, at the location related to the identified user information.

The computer that executes the information processing method described in claim 7 previously stores the user information associated with the location of the user and the acceptance or rejection of the registration, for each user with which the vehicle information relevant to the vehicle is capable of being registered. In the case of acquiring the search information for searching for the user, the computer identifies the user information corresponding to the search information, and presents the map information in which the user information that is of the identified user information and that is capable of accepting the registration is set on the map, at the location related to the identified user information. Thereby, in the case where the owner of the vehicle hopes to register the vehicle information about the vehicle in the database, the owner of the vehicle can reduce the burden of the seeking for the user that accepts the registration.

A storage medium described in claim 8 stores an information processing program for causing a computer to execute: a process of previously storing user information for each user with which vehicle information relevant to a vehicle is capable of being registered, the user information being associated with the location of the user and an acceptance or rejection of registration of data; a process of acquiring search information for searching for the user; a process of identifying the user information corresponding to the acquired search information; and a process of presenting map information in which a user capable of accepting the registration of the data is set on a map, at the location related to the identified user information.

The computer in which the information processing program stored in the storage medium described in claim 8 is executed previously stores the user information associated with the location of the user and the acceptance or rejection of the registration, for each user with which the vehicle information relevant to the vehicle is capable of being registered. In the case of acquiring the search information for searching for the user, the computer identifies the user information corresponding to the search information, and presents the map information in which the user information that is of the identified user information and that is capable of accepting the registration is set on the map, at the location related to the identified user information. Thereby, in the case where the owner of the vehicle hopes to register the vehicle information about the vehicle in the database, the owner of the vehicle can reduce the burden of the seeking for the user that accepts the registration.

With the present disclosure, in the case where the owner of the vehicle hopes to register the vehicle information in the database, the owner of the vehicle can reduce the burden of the seeking for the user that accepts the registration.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the schematic configuration of an information processing system according to an embodiment;

FIG. 2 is a block diagram showing the hardware configuration of a vehicle according to the embodiment;

FIG. 3 is a block diagram showing the functional configuration of an in-vehicle device according to the embodiment;

FIG. 4 is a block diagram showing the hardware configuration of a terminal according to the embodiment;

FIG. 5 is a block diagram showing the functional configuration of the terminal according to the embodiment;

FIG. 6 is a block diagram showing the hardware configuration of a center server according to the embodiment;

FIG. 7 is a diagram showing an example of user information according to the embodiment;

FIG. 8 is a diagram showing an example of vehicle information according to the embodiment;

FIG. 9 is a block diagram showing the functional configuration of the center server according to the embodiment;

FIG. 10 is a schematic diagram showing an example of map information according to the embodiment; and

FIG. 11 is a flowchart showing a flow of an information process that is executed in the center server according to the embodiment.

### DETAILED DESCRIPTION OF EMBODIMENTS

An information processing system including a vehicle, a terminal and a center server will be described. The vehicle is equipped with an in-vehicle device. The terminal is used when a user (special business operator) such as an insurer and a repairer registers information relevant to the vehicle, and is used when the owner of the vehicle searches for the user. The center server manages information relevant to the vehicle and information relevant to the user. The information processing system identifies and presents a user with which the information relevant to the vehicle can be registered, based on the acquired information.

Hereinafter, the special business operator is referred to as merely the “user”, the information relevant to the vehicle is referred to as “vehicle information”, and the information relevant to the user is referred to as “user information”. Further, in the embodiment described below, the vehicle information includes information acquired from the vehicle, as exemplified by a traveling distance and the situation of in-vehicle equipment, and information registered by the user, as exemplified by a repair history and an insurance use history.

Overall Configuration

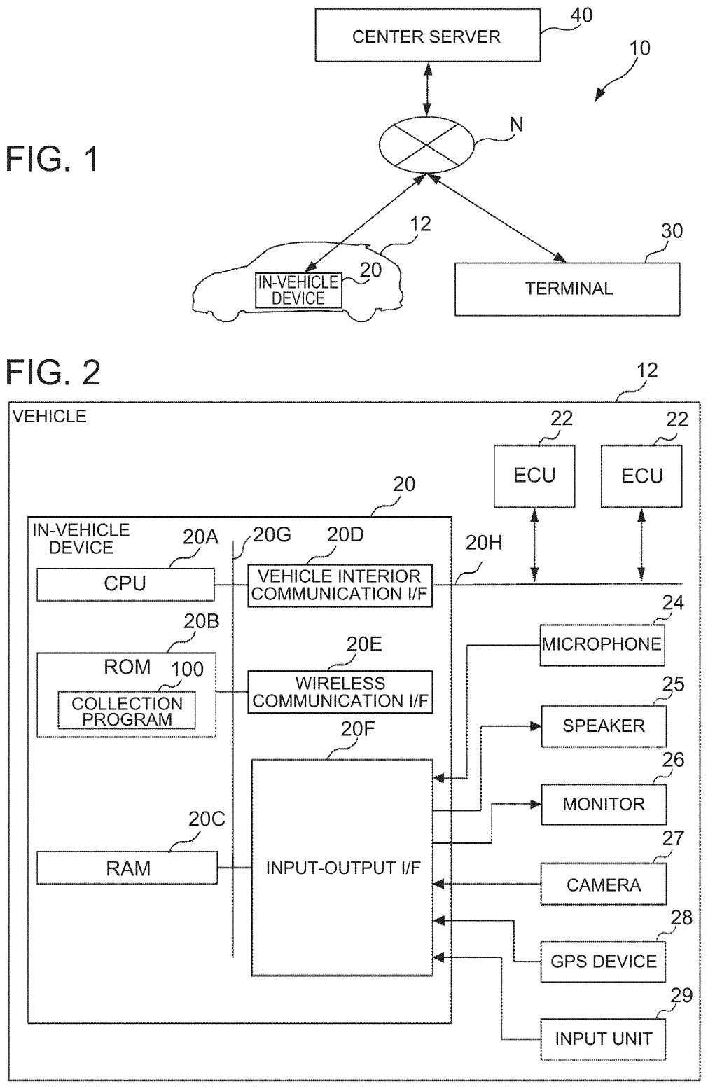

As shown in FIG. 1, an information processing system 10 according to the embodiment of the present disclosure is configured to include a vehicle 12, a terminal 30 and a center server 40. Further, the vehicle 12 is equipped with an in-vehicle device 20 as an in-vehicle apparatus. The in-vehicle device 20 and the terminal 30 are mutually connected with the center server 40 through a network N.

The in-vehicle device 20 collects the vehicle information including speed information indicating a speed at which the vehicle 12 travels, and information that is relevant to the state of the vehicle 12, as exemplified by defect, and that is collected from the in-vehicle equipment equipped in the vehicle, and sends the vehicle information to the center server 40.

The terminal 30 is a device that is operated by the owner of the vehicle 12 and the user, and is a personal computer, a tablet terminal or a portable terminal, for example. The terminal 30 sends the vehicle information that is input by the user and that includes the repair history and insurance use history about the vehicle 12, to the center server 40. Further, the terminal 30 sends information (referred to as “search information”, hereinafter) that is input by the owner of the vehicle 12 and that is used for searching for the user, to the center server 40, and receives a search result from the center server 40. For example, the search information is information that includes the name, attribute and address of the user, and a vehicle identification (ID) for identifying the owned vehicle 12.

For example, the center server 40 is installed in a manufacturer that manufactures the vehicle 12 or a car dealer that belongs to the manufacturer. The center server 40 acquires the vehicle information from the in-vehicle device 20 and the terminal 30, and stores the vehicle information. Further, the center server 40 stores the user information indicating the user. The center server 40 acquires the search information from the terminal 30, searches for and identifies the user, and sends the user information about the identified user, to the terminal 30.

Vehicle

As shown in FIG. 2, the vehicle 12 according to the embodiment is configured to include the in-vehicle device 20 and a plurality of electronic control units (ECUs) 22.

The in-vehicle device 20 is configured to include a central processing unit (CPU) 20A, a read only memory (ROM) 20B, a random access memory (RAM) 20C, a vehicle interior communication interface (I/F) 20D, a wireless communication I/F 20E, and an input-output I/F 20F/. The CPU 20A, the ROM 20B, the RAM 20C, the vehicle interior communication I/F 20D, the wireless communication I/F 20E and the input-output I/F 20F are connected through an internal bus 20G, such that communication can be mutually performed.

The CPU 20A, which is a central processing unit, executes a variety of programs and controls units. That is, the CPU 20A reads programs from the ROM 20B, and executes the programs using the RAM 20C as a work area.

In the ROM 20B, a variety of programs and a variety of data are recorded. In the ROM 20B in the embodiment, a collection program 100 is recorded. With the execution of the collection program 100, the in-vehicle device 20 executes a process of collecting data from unillustrated in-vehicle equipment and sensors and sending the data to the center server 40. The RAM 20C serves as a work area, and a program or data is temporarily recorded.

The vehicle interior communication I/F 20D is an interface for the connection with each ECU 22. For the interface, a communication standard by a CAN protocol is used. The vehicle interior communication I/F 20D is connected to an external bus 20H.

The wireless communication I/F 20E is a wireless communication module for communicating with the center server 40. For the wireless communication module, for example, a communication standard such as 5G, LTE and Wi-Fi (R) is used. The wireless communication I/F 20E is connected to the network N.

The input-output I/F 20F is an interface for communicating with a microphone 24, a speaker 25, a monitor 26, a camera 27, a GPS device 28 and an input unit 29 that are equipped in the vehicle 12. The microphone 24, the speaker 25, the monitor 26, the camera 27, the GPS device 28 and the input unit 29 may be directly connected to the internal bus 20G.

The ECU 22 is an electronic control module for controlling unillustrated in-vehicle equipment and sensors equipped in the vehicle 12. For example, the ECU 22 is an advanced driver assistance system (ADAS) ECU, a steering ECU, an engine ECU or the like.

The microphone 24 is a device that is provided at an instrument panel, a center console, a front pillar, a dashboard or the like and that collects a voice emitted by an occupant of the vehicle 12.

The speaker 25 is a device that is provided at the instrument panel, the center console, the front pillar, the dashboard or the like and that outputs a voice.

The monitor 26 is a liquid crystal monitor that is provided at the instrument panel, the dashboard or the like of the vehicle 12 and that displays a variety of information. Further, images and texts received from the center server are displayed on the monitor 26 in the embodiment.

The camera 27 is an image pickup device that is provided at an upper portion of a windshield or at a portion adjacent to a rearview mirror and that picks up the appearance of the occupant that rides in the vehicle 12.

The GPS device 28 is a device that measures the current place of the vehicle 12. The GPS device 28 includes an unillustrated antenna that receives signals from GPS satellites. The GPS device 28 may be connected with the in-vehicle device 20 through an unillustrated car navigation system.

The input unit 29 is a touch panel or button that accepts an input by a passenger of the vehicle 12.

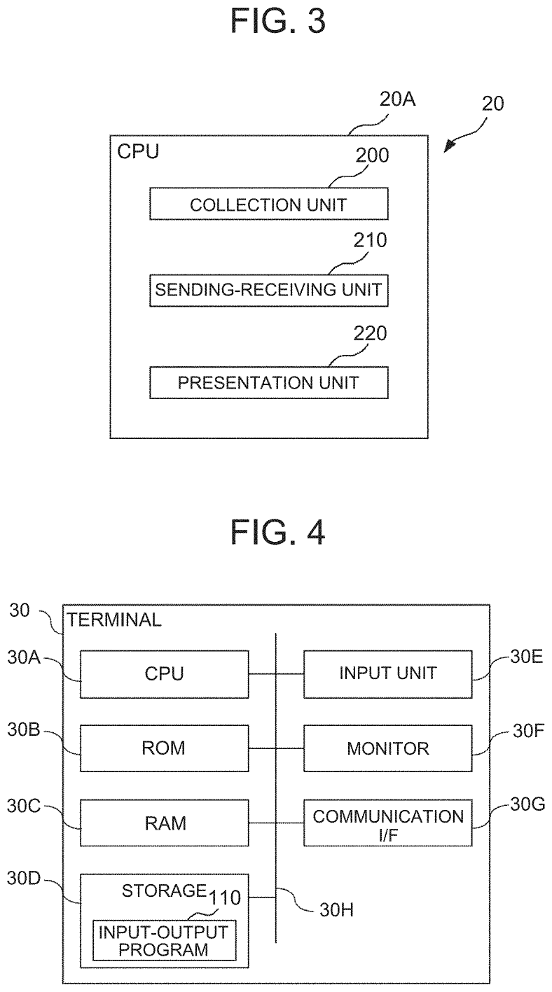

As shown in FIG. 3, in the in-vehicle device 20 in the embodiment, the CPU 20A executes the collection program 100, and thereby functions as a collection unit 200, a sending-receiving unit 210 and a presentation unit 220.

The collection unit 200 has a function to collect, from the ECUs 22, the speed information detected by the sensor, the information that is relevant to the state of the vehicle 12 and that is acquired from the unillustrated in-vehicle equipment, position information indicating the current place of the vehicle 12, and the like, as the vehicle information.

The sending-receiving unit 210 has a function to output the collected vehicle information to the center server 40 and to receive the map information from the center server 40.

The presentation unit 220 has a function to display the received map information on the monitor 26.

Terminal

As shown in FIG. 4, the terminal 30 is configured to include a CPU 30A, a ROM 30B, a RAM 30C, a storage 30D, an input unit 30E, a monitor 30F and a communication I/F 30G. The CPU 30A, the ROM 30B, the RAM 30C, the storage 30D, the input unit 30E, the monitor 30F and the communication I/F 30G are connected through an internal bus 30H, such that communication can be mutually performed. The functions of the CPU 30A, the ROM 30B, the RAM 30C and the communication I/F 30G are the same as the functions of the CPU 20A, the ROM 20B, the RAM 20C and the wireless communication I/F 20E of the above-described in-vehicle device 20. The communication I/F 30G may communicate by wire.

The storage 30D as a storage unit is constituted by a hard disk drive (HDD) or a solid state drive (SSD), and stores a variety of programs and a variety of data.

In the storage 30D in the embodiment, an input-output program 110 is stored. The input-output program 110 and the variety of data may be stored in the ROM 30B.

The input unit 30E is a button, a keyboard, a touch panel or the like for inputting characters and the like. The monitor 30F is a display device that displays image data, characters and the like.

The input-output program 110 as a program is a program for controlling the terminal 30. With the execution of the input-output program 110, the terminal 30 accepts the input of the vehicle information and the search information from the user, and displays the map information received from the center server 40, on the monitor 30F.

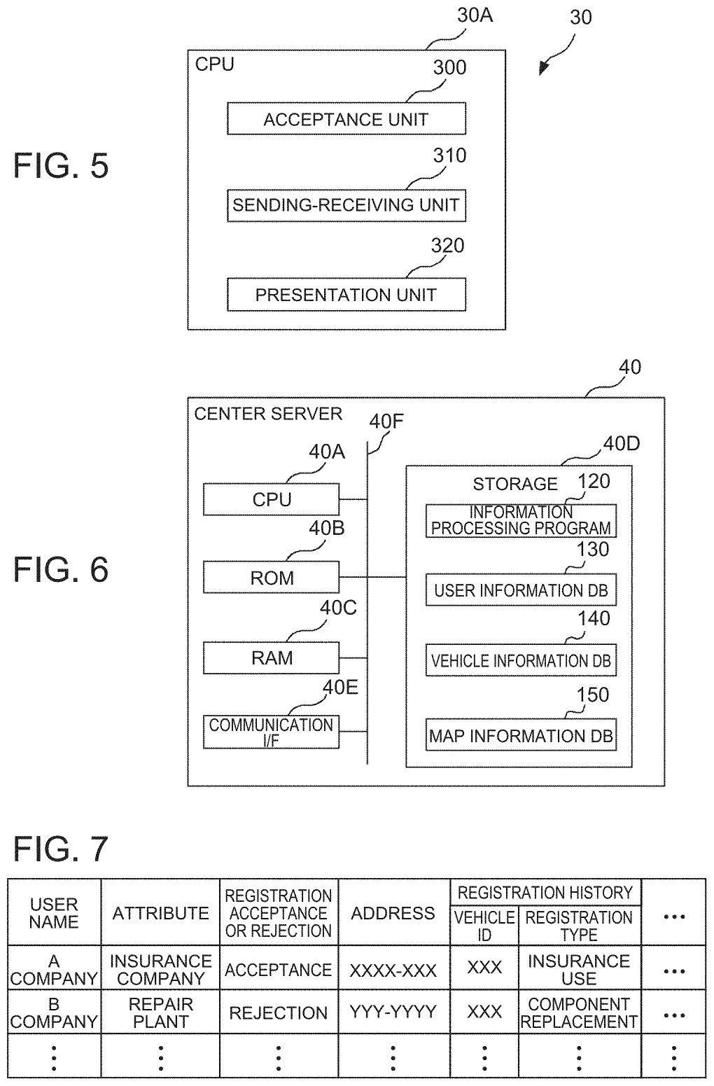

As shown in FIG. 5, in the terminal 30 in the embodiment, the CPU 30A executes the input-output program 110, and thereby functions as an acceptance unit 300, a sending-receiving unit 310 and a presentation unit 320.

The acceptance unit 300 accepts the vehicle information and search information input by the user.

The sending-receiving unit 310 has a function to send the accepted vehicle information and search information to the center server 40 and to receive the map information from the center server 40.

The presentation unit 320 has a function to present the received map information to the monitor 30F.

Center Server

As shown in FIG. 6, the center server 40 is configured to include a CPU 40A, a ROM 40B, a RAM 40C, a storage 40D and a communication I/F 40E. The CPU 40A, the ROM 40B, the RAM 40C, the storage 40D and the communication I/F 40E are connected through an internal bus 40F, such that communication can be mutually performed. The functions of the CPU 40A, the ROM 40B, the RAM 40C and the communication I/F 40E are the same as the functions of the CPU 20A, the ROM 20B, the RAM 20C and the wireless communication I/F 20E of the above-described in-vehicle device 20. The communication I/F 40E may communicate by wire.

The storage 40D as a storage unit is constituted by a HDD or a SSD, and stores a variety of programs and a variety of data. In the storage 40D in the embodiment, an information processing program 120, a user information database (DB) 130, a vehicle information DB 140 and a map information DB 150 are stored. The information processing program 120, the user information DB 130, the vehicle information DB 140 and the map information DB 150 may be stored in the ROM 30B.

The information processing program 120 as a program is a program for controlling the center server 40. With the execution of the information processing program 120, the center server 40 acquires the vehicle information from the in-vehicle device 20 and the terminal 30, and stores the vehicle information in the vehicle information DB 140. Further, the center server 40 acquires the search information from the terminal 30, and identifies the user information corresponding to the search information. The center server 40 sets the identified user information in the map information, and sends the map information to the terminal 30.

The user information DB 130 stores the user information relevant to the user. For example, as shown in FIG. 7, the user information DB 130 stores information including a user name, an attribute, a registration acceptance or rejection, an address and a registration history, as the user information. Further, the registration history includes a vehicle ID indicating a vehicle registered in the past and a registration type. The user name is the name of the user. The attribute is information indicating the business content of the user. The registration acceptance or rejection is information indicating whether the registration of the vehicle information by the user is accepted. The address is the location of the company, business office or others related to the user. The registration history is information registered by the user in the past. The vehicle ID is information for identifying the vehicle 12. The registration type is a type indicating the content (item) of an action or others registered by the user.

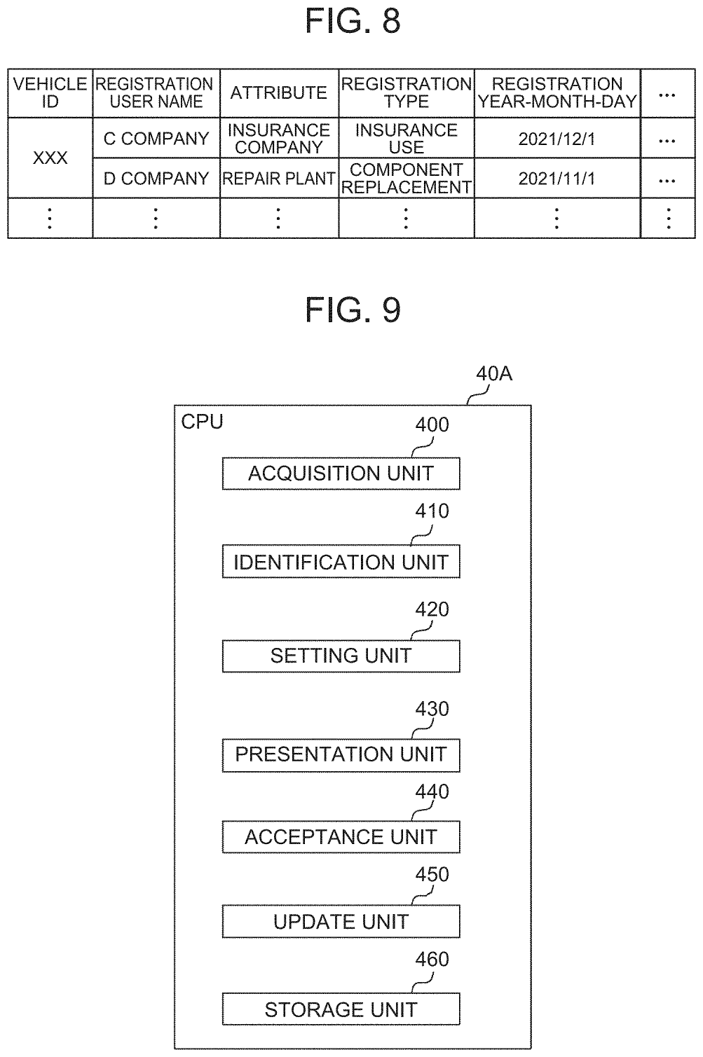

The vehicle information DB 140 stores the vehicle information that is relevant to the vehicle and that is acquired from the in-vehicle device 20 and the terminal 30. For example, as shown in FIG. 8, information including the vehicle ID, a registration user name, the attribute, the registration type and a registration year-month-day is stored as the vehicle information. The registration user name is the name of a user with which the vehicle information is registered. The registration year-month-day is a date when the vehicle information is registered. The registration content is information indicating a detailed content of the registered vehicle information.

The map information DB 150 stores the map information in which position information (addresses) about roads, buildings, facilities and others and forms of roads and alleys are associated.

Next, functions of the center server 40 will be described with reference to FIG. 9. For example, as shown in FIG. 9, in the center server 40 in the embodiment, the CPU 40A executes the information processing program 120, and thereby functions as an acquisition unit 400, an identification unit 410, a setting unit 420, a presentation unit 430, an acceptance unit 440, an update unit 450 and a storage unit 460.

The acquisition unit 400 has a function to acquire the vehicle information from the in-vehicle device 20 and the terminal 30. Further, the acquisition unit 400 has a function to acquire the search information from the terminal 30.

In the case of acquiring the search information, the identification unit 410 identifies the user information from the user information DB 130, using the search information. Specifically, the identification unit 410 searches for and identifies the user information corresponding to the name, attribute and address of the user included in the acquired search information, from the user information DB 130.

Further, using the vehicle ID included in the acquired search information, the identification unit 410 identifies the registration type corresponding to the vehicle ID, from the vehicle information DB 140. Using the identified registration type, the identification unit 410 identifies the user information corresponding to the registration type, from the user information DB 130.

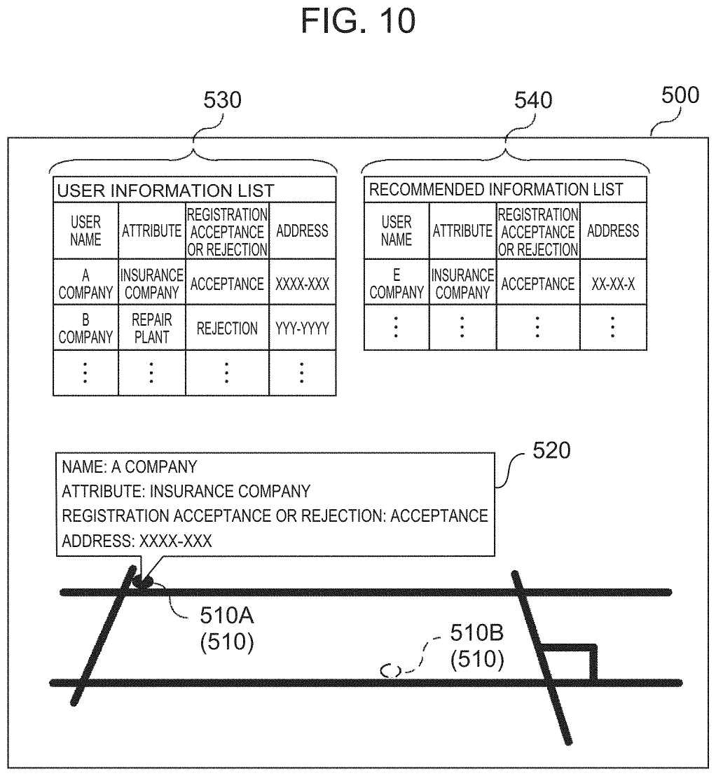

The setting unit 420 acquires the map information from the map information DB 150, and sets the user information identified using the search information, in the map information. Specifically, the setting unit 420 performs correspondence between the address related to the user information identified using the search information and the address in the map information. For example, as shown in FIG. 10, in map information 500, the setting unit 420 sets a marker 510 at the address related to the identified user information, and sets corresponding user information 520 on the marker 510 such that the user information 520 is superimposed. Further, the setting unit 420 sets the user information identified using the search information, in the map information, as a user information list 530.

The setting unit 420 sets the marker 510 depending on the registration acceptance or rejection related to the user information. For example, in the case where the registration acceptance or rejection related to the user information is “acceptance”, the setting unit 420 sets a marker 510A indicating “acceptance”, on the map, and sets the corresponding user information 520 in the map information such that the user information 520 is superimposed. In the case where the registration acceptance or rejection related to the user information is “rejection”, the setting unit 420 sets the map information by setting a marker 510B indicating “rejection”. In the embodiment, in the case where the registration acceptance or rejection is “rejection”, only the marker 510B is set on the map, as described above. However, the present disclosure is not limited to this. In the case where the registration acceptance or rejection is “rejection”, the user information may be further set on the map, or the registration acceptance or rejection related to the user information set on the map may be selected by the user and the user information related to the selected registration acceptance or rejection may be set on the map.

Further, the setting unit 420 sets the user information identified using the vehicle ID, in the map information, as recommended information indicating recommended users. For example, as shown in FIG. 10, the setting unit 420 sets the user information identified using the vehicle ID, in the map information, as a recommended information list 540 indicating recommended user information.

The presentation unit 430 sends and presents the map information in which the marker 510, the user information 520, the user information list 530 and the recommended information list 540 are set, to the terminal 30.

The acceptance unit 440 has a function to accept the alteration of the user information from the terminal 30.

The update unit 450 has a function to update the user information, using the alteration of the user information that is accepted from the terminal 30. For example, the update unit 450 accepts the user information in which the registration acceptance or rejection and the address are altered, from the terminal 30, and updates the corresponding user information stored in the user information DB 130, using the accepted user information.

The storage unit 460 has a function to store the acquired vehicle information in the vehicle information DB 140. Further, the storage unit 460 stores the user information and the vehicle information as the user information DB 130 and the vehicle information DB 140, respectively.

Flow of Control

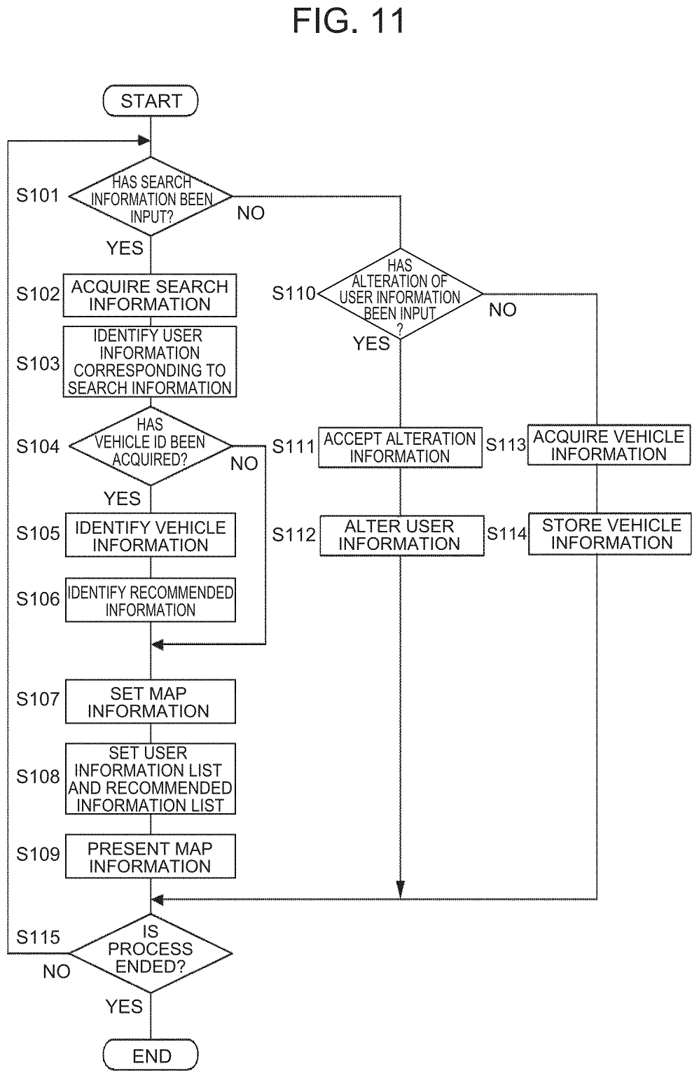

A flow of a process that is executed in the information processing system 10 in the embodiment will be described with use of a flowchart in FIG. 11. The information process in the center server 40 is executed when the CPU 40A of the center server 40 functions as the acquisition unit 400, the identification unit 410, the setting unit 420, the presentation unit 430, the acceptance unit 440, the update unit 450 and the storage unit 460. For example, the information process shown in FIG. 11 is executed, when the search information, the vehicle information or the alteration of the user information is input from the in-vehicle device 20 or the terminal 30.

In step S101, the CPU 40A determines whether the search information has been input. In the case where the search information has been input (step S101: YES), the CPU 40A transitions to step S102. On the other hand, in the case where the search information has not been input (step S101: NO), the CPU 40A transitions to step S110.

In step S102, the CPU 40A acquires the search information.

In step S103, the CPU 40A identifies the user information corresponding to the search information, from the user information DB 130, using the acquired search information.

In step S104, the CPU 40A determines whether the vehicle ID has been acquired together with the search information. In the case where the vehicle ID has been acquired (step S104: YES), the CPU 40A transitions to step S105. On the other hand, in the case where the vehicle ID has not been acquired (step S104: NO), the CPU 40A transitions to step S107.

In step S105, the CPU 40A identifies the vehicle information from the vehicle information DB 140, using the vehicle ID.

In step S106, as the recommended information, the CPU 40A identifies the user information corresponding to the registration history, from the user information DB 130, using the registration history registered in the identified vehicle information.

In step S107, the CPU 40A sets the address related to the identified user information, in the map information, such that the marker is superimposed.

In step S108, the CPU 40A sets the identified user information and recommended information in the map information, as the user information list and the recommended information list, respectively.

In step S109, the CPU 40A sends and presents the map information to the terminal 30.

In step S110, the CPU 40A determines whether the alteration of the user information has been input from the terminal 30. In the case where the alteration of the user information has been input (step S110: YES), the CPU 40A transitions to step S111. On the other hand, in the case where the alteration of the user information has not been input (the vehicle information has been input) (step S110: NO), the CPU 40A transitions to step S113.

In step S111, the CPU 40A accepts the alteration of the user information.

In step S112, the CPU 40A alters the user information stored in the user information DB 130, using the alteration of the user information.

In step S113, the CPU 40A acquires the vehicle information.

In step S114, the CPU 40A stores the acquired vehicle information in the vehicle information DB 140.

In step S115, the CPU 40A determines whether the information process is ended. In the case where the information process is ended (step S115: YES), the CPU 40A ends the information process. On the other hand, in the case where the information process is not ended (step S115: NO), the CPU 40A transitions to step S101.

### Summary of Embodiment

The center server 40 in the embodiment includes a storage unit that previously stores the user information associated with the location of the user and the acceptance or rejection of the registration of the data, for each user with which the vehicle information can be registered. The center server 40 acquires the search information for searching for the user, identifies the user information corresponding to the acquired search information, and presents the map information in which the user capable of accepting the registration of the data is set on the map, at the location related to the identified user information.

As described above, with the embodiment, in the case of hoping to register the vehicle information in the database, it is possible to reduce the burden of the seeking for the user that accepts the registration.

Supplement

In the above-described embodiment, the user information is identified using the search information accepted from the user. However, the present disclosure is not limited to this. For example, information (referred to as “narrow-down information”, hereinafter) for narrowing down the user from the user information list and recommended information list set in the map information may be accepted, and the user information may be narrowed down and identified using the narrow-down information. For example, in the presented map information, the center server 40 accepts the narrow-down information (for example, an address such as “Tokyo”) corresponding to the user information list and the recommended information list. The center server 40 identifies the user information set in the user information list and the recommended information list and corresponding to the narrow-down information, and presents a narrow-down result based on the narrow-down information by reflecting the identified user information in the user information list and the recommended information list on the map.

Further, in the above-described embodiment, the search information is accepted from the terminal 30. However, the present disclosure is not limited to this. The search information may be accepted from the vehicle 12. Further, in the above-described embodiment, the map information is sent and presented to the terminal 30. However, the present disclosure is not limited to this. The map information may be sent and presented to the vehicle 12. In this case, the in-vehicle device 20 sends the search information input through the input unit 29 by the owner of the vehicle 12, to the center server 40, and receives the map information from the center server 40, to display the map information on the monitor 26.

Further, in the above-described embodiment, the center server 40 sends and presents the map information in which the user information is set, to the terminal 30. However, the present disclosure is not limited to this. The center server 40 may present the map information by displaying the map information on an unillustrated monitor equipped in the center server 40.

Further, in the above-described embodiment, the center server 40 acquires the information such as the traveling distance and the situation of the in-vehicle equipment, from the in-vehicle device 20 of the vehicle 12. However, the present disclosure is not limited to this. The information such as the traveling distance and the situation of the in-vehicle equipment may be acquired from the terminal 30. For example, the terminal 30 may extract the information such as the traveling distance and the situation of the in-vehicle equipment, from the vehicle 12, and the extracted information may be sent to the center server 40 through the terminal 30.

Further, in the above-described embodiment, the recommended information that is the recommended user information is presented in a list. However, the present disclosure is not limited to this. The user information related to the recommended information may be set and presented on the map so as to be superimposed. In the case where the recommended information is superimposed on the map, the marker may be set with a different shape, color, pattern and the like, such that the recommended information can be distinguished from the user information identified from the search information.

Further, the various processes that the CPU 20A, the CPU 30A and the CPU 40A execute by reading software (programs) in the above embodiment may be executed by various processors other than CPUs. In this case, examples of the processors include a programmable logic device (PLD) allowing the circuit configuration to be altered after the production, as exemplified by a field-programmable gate array (FPGA), and a dedicated electric circuit that is a processor having a circuit configuration specially designed for executing a particular process, as exemplified by an application specific integrated circuit (ASIC). Further, the above-described processes may be executed by one of the various processors, or may be executed by a combination of two or more processors of the same or different kinds (for example, by a plurality of FPGAs or by a combination of a CPU and an FPGA). Further, more specifically, the hardware structure of the various processors is an electric circuit in which circuit elements such as semiconductor elements are combined.

Further, in the above-described embodiment, the programs are previously stored (installed) in a computer-readable non-transitory recording medium (storage medium). For example, the information processing program 120 in the center server 40 is previously stored in the ROM 40B. However, the present disclosure is not limited to this. The programs may be provided while being recorded in a non-transitory recording medium (storage medium) such as a compact disc read only memory (CD-ROM), a digital versatile disc read only memory (DVD-ROM) and a universal serial bus (USB) memory. Further, the programs may be downloaded from an external device through a network.

The flow of the process described in the above embodiment is an example, and an unnecessary step may be excluded, another step may be added, or the processing order may be changed without departing from the spirit.

What is claimed is:

1. An information processing device comprising:
a storage unit configured to previously store user information for each user with which vehicle information relevant to a vehicle is capable of being registered, the user information being associated with a location of the user and an acceptance or rejection of registration of data;
an acquisition unit configured to acquire search information for searching for the user;
an identification unit configured to identify the user information corresponding to the acquired search information; and
a presentation unit configured to present map information in which a user capable of accepting the registration of the data is set on a map, at the location related to the identified user information.

2. The information processing device according to claim 1, wherein the presentation unit presents map information in which a user that does not accept the registration of the data is further set on the map.

3. The information processing device according to claim 1, wherein:
the user information further includes an attribute of the user;
the search information further includes the attribute; and
the identification unit identifies the user information corresponding to the acquired attribute.

4. The information processing device according to claim 1, wherein the presentation unit further presents the identified user information in a list.

5. The information processing device according to claim 1, wherein:
the user information includes a registration history that is an item for the vehicle information registered by the user in the past;
the acquisition unit further acquires the vehicle information registered for the vehicle; and
the identification unit identifies the user information related to the registration history corresponding to the acquired vehicle information.

6. The information processing device according to claim 1, further comprising an acceptance unit configured to accept an alteration of the acceptance or rejection related to the user information.

7. An information processing method in which a computer executes:
a process of previously storing user information for each user with which vehicle information relevant to a vehicle is capable of being registered, the user information being associated with a location of the user and an acceptance or rejection of registration of data;
a process of acquiring search information for searching for the user;
a process of identifying the user information corresponding to the acquired search information; and
a process of presenting map information in which a user capable of accepting the registration of the data is set on a map, at the location related to the identified user information.

8. A non-transitory storage medium storing an information processing program for causing a computer to execute:
a process of previously storing user information for each user with which vehicle information relevant to a vehicle is capable of being registered, the user information being associated with a location of the user and an acceptance or rejection of registration of data;
a process of acquiring search information for searching for the user;
a process of identifying the user information corresponding to the acquired search information; and
a process of presenting map information in which a user capable of accepting the registration of the data is set on a map, at the location related to the identified user information.
